(19) United States
(12) Patent Application Publication
(10) Pub. No.: US 2012/0131472 A1
(43) Pub. Date: May 24, 2012

(54) APPARATUS AND METHOD FOR LOOK AND FEEL CUSTOMIZATION INCLUDING CONTEXT ANNOTATION

(75) Inventor: Shu WANG, Richardson, TX (US)

(73) Assignee: SAMSUNG ELECTRONICS CO. LTD., Suwon-si (KR)

(21) Appl. No.: 12/949,009

(22) Filed: Nov. 18, 2010

(51) Int. Cl. G06F 15/16; G06F 3/01

(52) U.S. Cl. 715/744; 709/217

(57) ABSTRACT

An apparatus and method for providing Look and Feel Customization (LFC) in a mobile terminal are provided. The method includes receiving an LFC Package including a plurality of LFC Element Settings to the mobile terminal, wherein at least one of the LFC Package and one of the LFC Element Settings are annotated with metadata regarding a context for use. By including LFC context metadata in an LFC Package or an LFC Element Setting, the mobile terminal is able to support context aware based LFC operations.

### BACKGROUND OF THE INVENTION

1. Field of the Invention

The present invention relates to an apparatus and method for Look and Feel Customization (LFC) in a mobile terminal. More particularly, the present invention relates to an apparatus and method for including metadata regarding context information for LFC operations in a mobile terminal.

2. Description of the Related Art

As mobile terminal technology has advanced, a mobile terminal is now able to be customized in many ways. For example, a mobile terminal may be customized by having a desired background or wallpaper displayed on its screen, may have certain of its keys allocated as a specific input for a desired function, may have a desired ring tone set for general telephone calls, may have a specific ring tone set for a specific caller, and the like. Such customization is defined by the Open Mobile Alliance (OMA) as Look and Feel Customization (LFC) and is discussed in the OMA Look and Feel Customization Requirements standard OMA-RD-LFC-V1_{—}0.

As part of LFC, many different entities are able to customize and configure a mobile terminal using an LFC package and an LFC enabler. For example, any of a service provider, a network operator, a handset manufacturer, a mobile terminal owner, and a mobile terminal user may configure and customize the mobile terminal provided the entity desiring customization has sufficient credentials or permissions to do so. Applying the configuration and customization information may be carried out by providing an LFC package, including LFC element data, and using any of a variety of enablers, such as an OMA Download Over-the-Air enabler, an OMA Device Management enabler, and the like. That is, the enabler allows for customization of the mobile terminal by receiving a set of LFC elements that may be rendered on the mobile terminal. In other words, an LFC enabler provides a framework by which the LFC elements relating to the background, wallpaper, ring tones, and other effects of the mobile terminal can be provided with data.

One aspect of mobile terminal customization that has become important is context aware customization. When provided with context aware customization, a mobile terminal may be customized based on the context in which it is being used. For example, an LFC element of the mobile terminal, such as the wallpaper or ring tone, may be automatically changed based on the context in which the mobile terminal is being used, such as its location. Use of context based customization has several advantages. For example, it can make a mobile terminal more intelligent and adaptive and thus provide an enhanced user experience. It can also reduce the complexity of LFC operations and maintain a more consistent LFC for a mobile terminal. However, the LFC packages used by the OMA LFC enablers do not support context based LFC operations.

Accordingly, there is a need for an improved apparatus and method for providing context based customization in a mobile terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for supporting context based Look and Feel Customization (LFC) in a mobile terminal.

Another aspect of the present invention is to provide an apparatus and method for annotating an LFC Package with metadata for context based operations in a mobile terminal.

Yet another aspect of the present invention is to provide an apparatus and method for annotating an LFC Element Setting with metadata for context based operations in a mobile terminal.

Still another aspect of the present invention is to provide an apparatus including a context aware agent for controlling context based LFC operations in a mobile terminal.

In accordance with an aspect of the present invention, a method for providing a user interface in a mobile terminal having a software mode and a hardware mode is provided. The method includes receiving an LFC Package including a plurality of LFC Element Settings by the mobile terminal, wherein at least one of the LFC Package and one of the LFC Element Settings is annotated with metadata regarding a context for use.

In accordance with another aspect of the present invention, an apparatus for providing a user interface in a mobile terminal having a software mode and a hardware mode is provided. The apparatus includes a controller for receiving an LFC Package including a plurality of LFC Element Settings, wherein at least one of the LFC Package and one of the LFC Element Settings is annotated with metadata regarding a context for use.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A illustrates a Look and Feel Customization (LFC) system according to the related art;

FIG. 1B illustrates an LFC Package according to the related art;

FIG. 2 illustrates an LFC Package including context annotation according to an exemplary embodiment of the present invention;

FIG. 3 illustrates an LFC Package including individual LFC Element Settings having context annotation according to an exemplary embodiment of the present invention; and

FIG. 4 illustrates an LFC Agent according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following exemplary embodiments of the present invention are described as applied to a “mobile terminal.” However, it is to be understood that this is merely a generic term and that the invention is equally applicable to any of a mobile phone, a palm sized Personal Computer (PC), a Personal Digital Assistant (PDA), a Hand-held PC (HPC), a smart phone, an International Mobile Telecommunication 2000 (IMT-2000) terminal, a wireless Local Area Network (LAN) terminal, and the like. Accordingly, use of the term “mobile terminal” should not be used to limit application of the present inventive concepts to any certain type of apparatus or device.

Exemplary embodiments of the present invention include an apparatus and method for providing Look and Feel Customization (LFC) that includes context metadata. Furthermore, according to exemplary implementations of the present invention, context metadata may be associated with either or both of an LFC Package and an LFC Element.

To assist in an understanding of the present invention, an LFC system and an LFC Package of the related art will first be described.

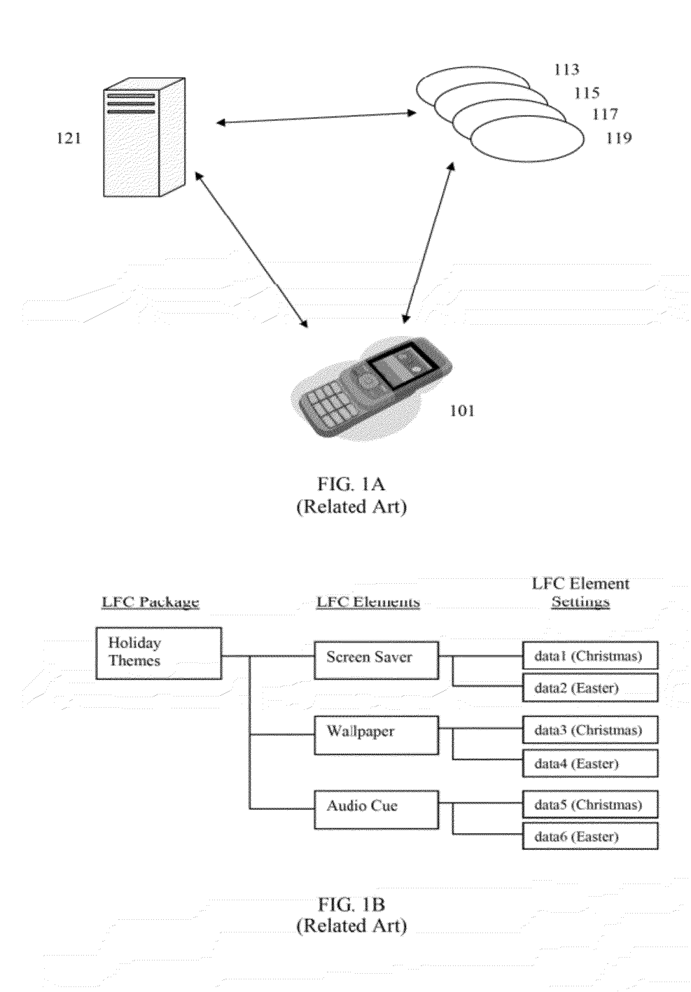

FIG. 1A illustrates an LFC system according to the related art and FIG. 1B illustrates an LFC Package according to the related art.

Referring to FIGS. 1A and 1B, the LFC system includes a mobile terminal 101, and a plurality of LFC Content Servers 113, 115, 117, and 119. Also illustrated in FIG. 1A is an LFC Management Server 121. According to various implementations, the LFC system may be provided as one of a lightweight model or a remote management model. If implemented as a lightweight model, the LFC system includes an LFC client, located locally with the mobile terminal 101, and LFC Content Servers 113, 115, 117, and 119. On the other hand, if implemented as a remote management model, the LFC system includes an LFC client, located locally with the mobile terminal 101, LFC Content Servers 113, 115, 117, and 119, and an LFC Management Server 121. Thus, while FIG. 1A illustrates implementation of the LFC system as a remote management model for convenience, it may also be implemented as a lightweight model in which case the LFC system need not include the LFC Management Server 121. In the LFC system, items that may be customized on a mobile terminal are referred to as LFC Elements. In the example of FIG. 1B, LFC Elements include a screensaver, wallpaper, and an audio cue. However, the LFC Elements may further include any or all of a background, a ring tone, a sound, a start-up/shut-down experience, an animation, a splash screen, a status indicator, a font, and the like. In the LFC system of FIG. 1A, each of the plurality of LFC Content Servers 113-119 offers specific content data that may be used to customize any of the LFC Elements of the mobile terminal 101. The content data associated with an LFC Element is referred to as an LFC Element Setting and is provided by any of LFC Content Servers 113-119 in an LFC Package. For example, a content server may offer content data regarding holiday themes that may be used to customize the look and feel of the mobile terminal 101 during the time of a corresponding holiday. In such a case and with reference again to FIG. 1B, a content server may offer an LFC Package of Holiday Themes for use on the mobile terminal 101. As further illustrated in FIG. 1B, the Holiday Themes LFC Package contains LFC Element Settings (e.g., data 1, data 2) for certain LFC Elements that may be used to customize the look and feel of the mobile terminal 101. More specifically, the LFC Package contains data1, data3, and data5 that are associated with a Christmas theme, and data2, data4, and data6 that are associated with an Easter theme. Furthermore, data1 and data2 are associated with a screen saver LFC Element, data3 and data4 are associated with a wallpaper LFC Element, and data5 and data6 are associated with an audio cue LFC Element. Accordingly, if a user desired to customize the mobile terminal 101 with a Christmas theme, the user may select LFC Element Settings of data1, data3, and data5, to respectively customize the screen saver, wallpaper, and audio cue of the mobile terminal 101. The LFC Package may also contain information that identifies the LFC Elements with which the data is associated, and may provide operational instructions required for their installation or activation.

For customization of the mobile terminal 101 using an LFC Package available from one of the LFC Content Servers 113-119, the LFC Package may be received by different methods depending on whether the LFC system is implemented as a lightweight model or a remote management model. For example, if implemented as a lightweight model, the LFC client, located locally with the mobile terminal, sends a download request to a Delivery Client (not shown). The Delivery Client downloads metadata of the requested LFC Package from a source location (e.g., one of LFC Content Servers 113, 115, 117, and 119), sends a user authorization request to the LFC client, and forwards the metadata of the content. The LFC client evaluates the metadata received from the Delivery Client to verify that the mobile terminal has the capability to process the LFC Package, forwards a user authorization request to and receives an authorization result from the mobile terminal, and forwards the authorization result to the Delivery Client. Finally, the Delivery Client downloads the LFC Package and makes it available to the LFC client. When implemented as a remote management model, the LFC Management Server 121 notifies a Device Management (DM) Server (not shown) to deliver the LFC Package to the mobile terminal. The DM Server notifies a DM Client (not shown) to initiate a DM session. The LFC Management Server 121 sends a deliver LFC Operation to the LFC client over the DM session wherein the LFC client executes the deliver operation and uses an appropriate download method to retrieve the LFC Package, such as a method explained above regarding use of the lightweight model. Finally, the LFC client acknowledges receipt of the LFC Package and informs the LFC Management Server 121 using the DM session. The appropriate LFC Content Server also transmits the desired LFC Element Settings (i.e., data 1-data6) which are provided to the mobile terminal 101 for installation and use. Once installed on the mobile terminal 101, the LFC Package and LFC Element Settings may be selected and executed at the option of the user. Furthermore, when the remote management model is implemented, the LFC Package operations can be issued by the LFC Management Server 121.

In the LFC system of the related art as illustrated in FIG. 1A, an LFC Package including LFC Element Settings as illustrated in FIG. 1B is provided to a mobile terminal. In that case, the mobile terminal may select an LFC Element Setting to be applied to an appropriate LFC Element to customize the look and feel of the mobile terminal. However, there is no mechanism in the LFC Package or LFC Element Settings of FIG. 1B with which to support context aware LFC operations.

To support context aware based LFC operations, exemplary embodiments of the present invention annotate at least one of an LFC Package and an LFC Element Setting with metadata. By incorporating the metadata, an LFC Enabler is made aware of the corresponding context of the LFC Package or LFC Element Setting and can adaptively and intelligently perform LFC operations. As will be explained in more detail below, exemplary embodiments of the present invention include metadata as an annotation to either or both of an LFC Package and an LFC Element Setting. Furthermore, the annotation may include context information and/or a rule regarding the LFC Package and/or LFC Element Setting.

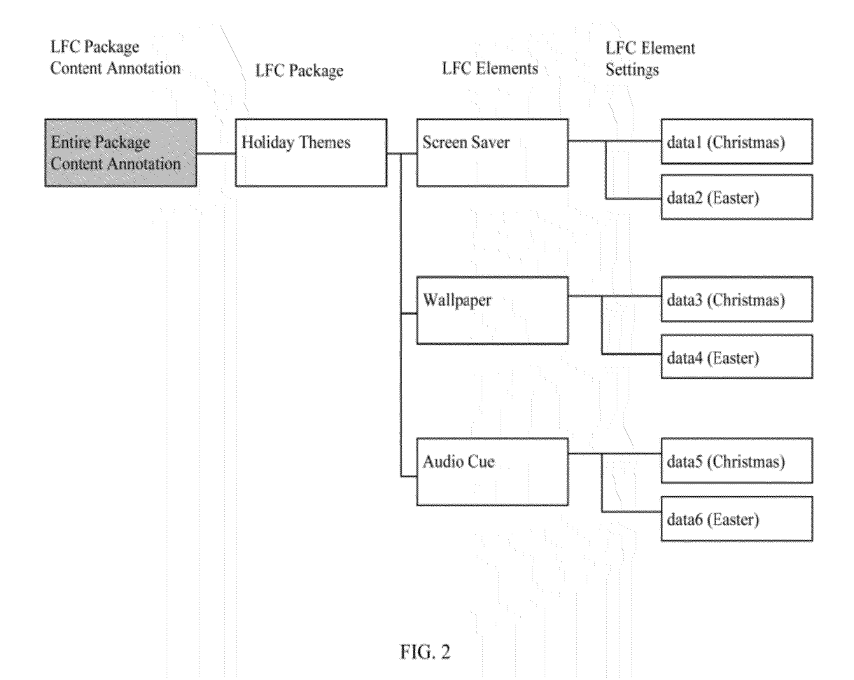

FIG. 2 illustrates an LFC Package including context annotation according to an exemplary embodiment of the present invention.

Referring to FIG. 2, an LFC Package is provided regarding holiday themes that may be used to customize the look and feel of a mobile terminal. The LFC Package includes LFC Element Settings associated with LFC Elements of a screen saver, wallpaper, and an audio cue. More particularly, the LFC Package includes data1 and data2 as LFC Element Settings regarding a screen saver, data3 and data4 as LFC Element Settings regarding wallpaper, and data5 and data6 as LFC Element Settings regarding an audio cue. According to an exemplary embodiment of the present invention, the entire LFC Package is annotated with context metadata. More specifically, the entire LFC Package is annotated with information regarding the context in which the LFC Package may be used and/or rules regarding use of the LFC Element Settings associated with the LFC Package.

In an exemplary implementation, the LFC Package may be annotated with metadata regarding a rule for use of the LFC Package. As an example, the rule may require that all LFC Element Settings associated with the LFC Package be activated together, or else none of the LFC Element Settings associated with the LFC Package can be activated If such a rule is associated with an LFC Package using context metadata, when an LFC Element Setting activation operation is issued, the operation will be disallowed based on the rule associated with the LFC Package through the context metadata. For example, if a user of the mobile terminal attempted to activate a Christmas screen saver using the data1 LFC Element Setting, the activation would not be allowed based on the rule associated with the LFC Package. Upon disallowance of the LFC Element Setting activation, the mobile terminal may recommend an appropriate or allowed operation in its place. For example, the mobile terminal may recommend that the entire LFC Package be activated for the Christmas theme. It is to be understood that a rule associated with the LFC Package may apply only to some of the LFC Element Settings of the LFC Package that meet certain criteria as opposed to all LFC Element Settings of the LFC Package. Thus as an example, a rule of the LFC Package may apply to the data1 and data3 LFC Element Settings regarding the screen saver and wallpaper for a Christmas theme, but not apply to the data5 Element Setting regarding the audio cue for the Christmas theme. Similarly, while the LFC Package includes themes for both Christmas and Easter, an LFC Package rule may be applicable only to the LFC Element Settings associated with Christmas.

In yet another exemplary implementation, the LFC Package context metadata may be used to provide information to the user regarding use of a selected LFC Element Setting. That is, the LFC Package context metadata may be used to suggest a further look and feel customization that may be made based on a user's selection. For example, if the user desired to customize the screen saver of the mobile terminal with a Christmas theme by using the data1 LFC Element Setting, the mobile terminal, based on the LFC Package context annotation, may further inform the user that the wallpaper and audio cue may be similarly customized with a Christmas theme.

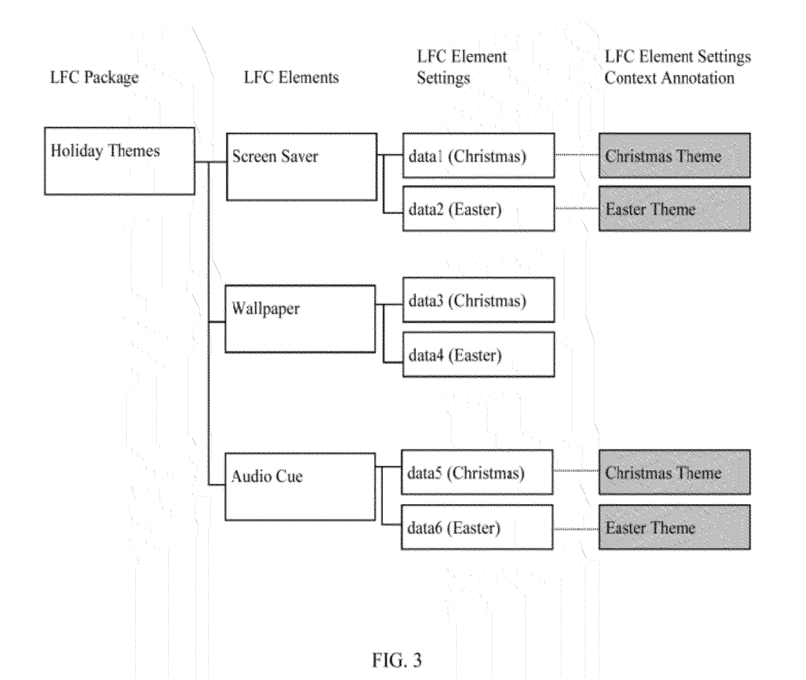

FIG. 3 illustrates an LFC Package including individual LFC Element Settings having context annotation according to an exemplary embodiment of the present invention.

Referring to FIG. 3, an LFC Package again includes LFC Element Settings associated with LFC Elements of a screen saver, wallpaper, and an audio cue. More particularly, the LFC Package includes data1 and data2 as LFC Element Settings regarding a screen saver, data3 and data4 as LFC Element Settings regarding wallpaper, and data5 and data6 as LFC Element Settings regarding an audio cue. According to an exemplary embodiment of the present invention, certain of the LFC Element Settings are annotated with context metadata. In the illustrated example of FIG. 3, the data1 and the data2 LFC Element Settings associated with the screen saver and the data5 and the data6 LFC Element Settings associated with the audio cue are annotated with metadata, while the data3 and data4 LFC Element Settings associated with wallpaper are not annotated. By selectively annotating certain of the LFC Element Settings, context based LFC operations can be achieved. That is, the LFC Element Settings can be annotated with metadata regarding rules or information associated with the context in which the LFC Element Setting may be used.

More specifically, an LFC Element Setting may be annotated with information or a rule regarding the context in which the LFC Element Setting may be used. As an example, if a user activates a Christmas screen saver and the current time or date is Christmas day, the LFC client infers that the user may want to change the mobile terminal's look and feel to a Christmas theme. In that case, the LFC client automatically identifies other related LFC Element Settings (e.g. Christmas audio cue) in the mobile terminal, and recommends them to the user for further activation.

In another exemplary implementation, an LFC Element Setting may be annotated with context metadata associated with a rule regarding use of the LFC Element Setting. As an example, the vendor of a mobile terminal may use context metadata to add a security authorization rule to an LFC Element Setting. Such a rule may be used to protect the LFC Element Setting from unauthorized changes by an operator or user of the mobile terminal.

In another exemplary embodiment, the LFC Element itself may be annotated with context metadata. As an example, an LFC Element regarding the wallpaper used by a mobile terminal may be annotated with context metadata such that the wallpaper is automatically changed at a certain time. In that case, during normal working hours established by the user of the mobile terminal, the wallpaper displayed on the mobile terminal may be work related wall paper. However, after normal working hours, the wallpaper may be automatically changed to the user's favorite personal wallpaper.

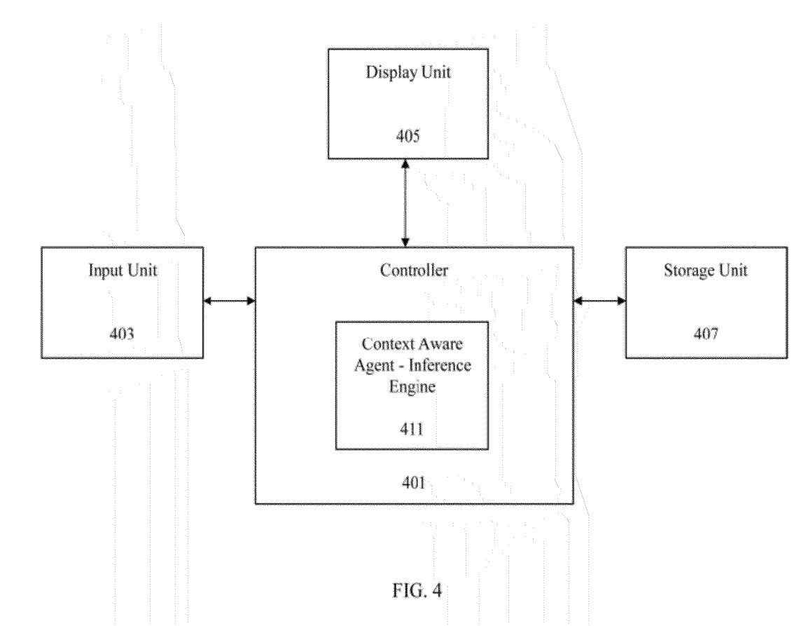

FIG. 4 illustrates a mobile terminal including an LFC context aware agent according to an exemplary embodiment of the present invention.

Referring to FIG. 4, a mobile terminal includes a controller 401, an input unit 403, a display unit 405, and a storage unit 407. The controller 401 controls the overall functions of the mobile terminal including the provision of LFC operations. According to an exemplary embodiment of the present invention, the controller 401 includes an LFC context aware agent 411 having an inference engine.

The input unit 403 includes a plurality of keys used to receive input from a user. The plurality of keys may include alpha-numeric character keys, function keys, soft keys, and the like. Upon selection of a key by a user, the input unit 403 provides a signal corresponding to the selected key to the controller 401. More specifically, upon execution of an LFC operation, the keys may be used to receive a user selection and provide corresponding input to the controller 401 regarding the customization of the mobile terminal. For example, the input unit 403 may be used to select an LFC Element Setting regarding an LFC Element that the user desires to customize. In an exemplary implementation, the functions of the soft keys of the input unit 403 may be designated for selection of menu items related to an LFC operation. Of course, it is to be understood that an LFC operation may be executed not only by a user through the input unit 403 but also by a remote management server if the remote management model is implemented. Thus, the illustration of the input unit 403 in FIG. 4 is not to be construed as limiting the scope of the invention to executing of an LFC operation by the mobile terminal only.

The display unit 405 is used to display various functions output by the controller 401 and provides a visual interface for a user of the mobile terminal For example, the display unit 405 displays a call mode, a standby mode, and other various operating modes of the mobile terminal, menus associated with various functions of the mobile terminal, keys or other input selected using the input unit 403, files or other data stored in the storage unit 407, and the like. The display unit 405 also displays LFC operations such as menus for selection of an LFC Package or LFC Element Setting to customize the mobile terminal, messages regarding an LFC Package or an LFC Element Setting, and the like. The display unit 405 may be provided as a Liquid Crystal Display (LCD). In this case, the display unit 405 may include a controller for controlling the LCD, a video memory in which image data is stored and an LCD element. If the LCD is provided as a touch screen, the display unit 405 may perform a part or all of the functions of the input unit 403.

The storage unit 407 includes volatile and non-volatile memories for storing temporary data associated with execution of various functions by the mobile terminal and data that is to be stored for a longer term. For example, the long term data may include an LFC Package provided with the mobile terminal by the manufacturer or selected by a user and received from a content server. According to an exemplary embodiment of the present invention, the storage unit 407 may also store context based metadata associated with an LFC Package and/or an LFC Element Setting.

The context aware agent 411 includes an inference engine and is provided for context based LFC operations. More specifically, the context aware agent 411 is provided with input from the input unit 403 and with data from the storage unit 407 such that an LFC operation can be based on the context of the mobile terminal.

In an exemplary implementation, when an LFC operation is requested or otherwise begun, it is first provided to the context aware agent 411. For example, if a user selects an input regarding an LFC customization operation, such as selecting to apply an LFC Package or an LFC Element Setting with which to customize an LFC Element, the input selection is provided to the context aware agent 411. Upon receipt of the selected input, the context aware agent 411 retrieves corresponding context metadata from the storage unit 407. The corresponding metadata may include context information and/or rules associated with the LFC Package or LFC Element Setting of the received input. Using the retrieved context metadata, the context aware agent 411 is able to intelligently determine appropriate application of the selected LFC operation. For example, the context aware agent 411 may determine that the selected LFC operation may be executed as requested without additional input from the user, such as security authorization, without additional suggestions to the user regarding related customizations, and the like. In such a case, the context aware agent 411 may determine that the selected LFC operation is not associated with context metadata or alternatively may determine that any conditions or rules associated with the context metadata are satisfied. If the context aware agent 411 determines that the selected LFC operation may be executed without further action, the context aware agent 411 may provide an output to the display unit 405 indicating that the selected LFC operation is accepted. Alternatively, the context aware agent 411 may simply allow the selected LFC operation to continue without providing an output to the display unit 405. In either case, the context aware agent 411 forwards the selected LFC operation for execution by the control unit 401.

The context aware agent 411 may also determine that the selected LFC operation is not allowable based on the retrieved context metadata. In that case, the context aware agent 411 may provide an output to the display unit 405 indicating that the selected LFC operation is not allowed. The context aware agent 411 may also provide menu options or other means to allow the user to input various parameters to overcome the disallowance of the selected LFC operation. For example, the context aware agent 411 may provide a menu that allows the user to input a password or other authorization to satisfy a security requirement, or may provide a menu allowing the user to select an entire LFC Package if the context metadata is a rule requiring that an entire LFC Package must be used rather than a single LFC Element Setting from the LFC Package.

The context aware agent 411 may further determine that a related LFC operation may be executed based on the selected LFC operation. In that case, the context aware agent 411 may provide an output to the display unit 405 indicating that, based on the selected LFC operation, the retrieved context metadata associated with the selected LFC operation indicates that similar or related LFC operations may be advantageously selected. More specifically, the context aware agent 411 may provide an output to the display unit 405 recommending an additional LFC operation and provide a menu allowing the user to select whether to apply the recommended LFC operation. If the recommended LFC operation is selected, the context aware agent 411 receives the selection, retrieves LFC Element Settings and/or an LFC Package regarding the recommended LFC operation, and forwards the information to the controller 401 for execution and implementation. Otherwise, the context aware agent 411 proceeds with the originally selected LFC operation. In an exemplary implementation, the recommendation provided by the context aware agent 411 may be based on a previous LFC operation result.

The exemplary embodiments of the present invention as described above provide an improved apparatus and method for LFC operations that are more intelligent and adaptive to the context in which the mobile terminal is used. The context aware agent, including the inference engine, can continuously utilize context information and rules to intelligently determine and recommend additional LFC operations. Moreover, the exemplary embodiments may prevent invalid LFC operations in advance, maintain a consistent look and feel of a mobile terminal, reduce the complexity of LFC operations, support security authorizations, and provide automatic alerts and recommendations to the user regarding suggested LFC operations based on the context in which the mobile terminal is operating.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for context based Look and Feel Customization (LFC) in a mobile terminal, the method comprising:
receiving an LFC Package including a plurality of LFC Element Settings by the mobile terminal,
wherein at least one of the LFC Package and one of the LFC Element Settings is annotated with metadata regarding a context for use.

2. The method of claim 1, wherein the metadata regarding the context for use of the at least one LFC Package and one of the LFC Element Settings includes at least one of a rule and context information.

3. The method of claim 1, further comprising:
receiving an input for execution of at least one of the LFC Package and one or more of the plurality of LFC Element Settings;
evaluating the metadata associated with the at least one of the LFC Package and the one or more of the plurality of LFC Element Settings; and
executing the at least one of the LFC Package and one or more of the plurality of LFC Element Settings based on the evaluation of the metadata.

4. The method of claim 3, wherein the receiving of the input comprises receiving input for execution of the LFC Package, and further wherein the evaluating of the metadata comprises determining if the metadata includes a rule requiring application of the entire LFC Package.

5. The method of claim 4, further comprising, if it is determined that the metadata requires application of the entire LFC Package, displaying an indication regarding application of the entire LFC Package.

6. The method of claim 3, wherein the receiving of the input comprises receiving input for execution of one or more of the LFC Element Settings, and further wherein the evaluating of the metadata comprises determining if the metadata includes context information regarding the one or more of the LFC Element Settings.

7. The method of claim 6, further comprising, if it is determined that the metadata includes context information regarding the one or more of the LFC Element Settings, determining if another LFC Element Setting includes related metadata.

8. The method of claim 7, wherein, if it is determined that another LFC Element Setting includes related metadata, displaying an indication regarding execution of the other LFC Element Setting.

9. An apparatus for context based Look and Feel Customization (LFC) in a mobile terminal, the apparatus comprising:
a controller for receiving an LFC Package including a plurality of LFC Element Settings,
wherein at least one of the LFC Package and one of the LFC Element Settings is annotated with metadata regarding a context for use.

10. The apparatus of claim 9, wherein the metadata regarding the context for use of the at least one LFC Package and one of the LFC Element Settings includes at least one of a rule and context information.

11. The apparatus of claim 9, further comprising a context aware agent for receiving an input for execution of at least one of the LFC Package and one or more of the plurality of LFC Element Settings, for evaluating the metadata associated with the at least one of the LFC Package and the one or more of the plurality of LFC Element Settings, and for executing the at least one of the LFC Package and one or more of the plurality of LFC Element Settings based on the evaluation of the metadata.

12. The apparatus of claim 11, wherein the context aware agent receives the input by receiving input for execution of the LFC Package, and evaluates the metadata by determining if the metadata includes a rule requiring application of the entire LFC Package.

13. The apparatus of claim 12, further comprising a display unit for displaying an indication regarding application of the entire LFC Package if it is determined by the context aware agent that the metadata requires application of the entire LFC Package.

14. The apparatus of claim 11, wherein the context aware agent receives the input by receiving input for execution of one or more of the LFC Element Settings, and evaluates the metadata by determining if the metadata includes context information regarding the one or more of the LFC Element Settings.

15. The apparatus of claim 14, wherein the context aware agent determines if another LFC Element Setting includes related metadata, if it is determined that the metadata includes context information regarding the one or more of the LFC Element Settings.

16. The apparatus of claim 15, further comprising a display unit for displaying an indication regarding execution of the other LFC Element Setting, if it is determined that another LFC Element Setting includes related metadata.
